(19) United States
(12) Patent Application Publication
(10) Pub. No.: US 2023/0365350 A1
(43) Pub. Date: Nov. 16, 2023

(54) Non-Contact Conveyance Device

(71) Applicant: KOGANEI CORPORATION, Tokyo (JP)

(72) Inventors: Ryosuke SATO, Tokyo (JP); Akihiro ORUI, Tochigi (JP)

(73) Assignee: KOGANEI CORPORATION, Tokyo (JP)

(21) Appl. No.: 18/355,979

(22) Filed: Jul. 20, 2023

Related U.S. Application Data
(63) Continuation of application No. PCT/JP2022/001767, filed on Jan. 19, 2022.

(30) Foreign Application Priority Data
Jan. 22, 2021 (JP) 2021-008539

(51) Int. Cl. B65G 47/91

(52) U.S. Cl. CPC B65G 47/911; B65G 2201/0202

(57) ABSTRACT

A non-contact conveyance device includes a conveyance head in which a flat facing surface opposing a conveyed object is formed, a gas supply port connected to a supply source of compressed air is provided in the conveyance head, each of ejection ports of a plurality of ejection paths that communicate with the supply port and are formed in the conveyance head is provided at a position separated by an opening distance from a holding center point of the facing surface, an inclination angle of the ejection path with respect to the facing surface is set to an acute angle, and the compressed gas ejected from each of the ejection ports flows along the facing surface and holds the conveyed object without causing the convey object to contact with the facing surface.

### CROSS-REFERENCE TO RELATED APPLICATIONS

This is a continuing application, under 35 U.S.C. § 120, of copending international application No. PCT/JP2022/001767, filed Jan. 19, 2022, which designated the United States and was not published in English; this application also claims the priority, under 35 U.S.C. § 119, of Japan patent application No. 2020-008539, filed Jan. 1, 2021; the prior applications are herewith incorporated by reference in their entirety.

### STATEMENT REGARDING FEDERALLY SPONSORED RESEARCH OR DEVELOPMENT

Not Applicable

### FIELD OF THE INVENTION

The present systems, apparatuses, and methods lie in the field of non-contact conveyance devices. The present disclosure relates to a non-contact conveyance device that holds and conveys an object to be conveyed (a conveyed object) in a non-contact manner.

### BACKGROUND OF THE INVENTION

Non-contact conveyance devices are used to convey not only machine parts but also foods as objects to be conveyed. As described in Japanese Patent Application Laid-open No. 219922, a conventional non-contact conveyance device has a form including: a conveyance head that has a concave portion formed on a tip surface thereof; and a disk-shaped nozzle provided at a center of the concave portion.

The concave portion has an annular holding surface and a gas guide surface that gently curves and is continuous from a central portion toward the holding surface, and gas ejected from a slit between the nozzle and the tip surface of the conveyance head flows radially outward after reaching the holding surface along the gas guide surface. Since a front of the tip surface of the conveyance head is in a negative pressure state due to an airflow directed toward the tip surface and when the conveyed object is arranged in front of the conveyance head, the conveyed object is attracted to the conveyance head by the negative pressure and approaches it.

The airflow flowing along the holding surface prevents the conveyed object from directly contacting with the holding surface, and the conveyed object is sucked and held in a non-contact state with the conveyance head. The conveyed object can be conveyed by moving the conveyance head.

Thus, a need exists to overcome the problems with the prior art systems, designs, and processes as discussed above.

### SUMMARY OF THE INVENTION

When soft food materials such as pie dough, bread dough, and gyoza wrappers among the objects to be conveyed are conveyed by a conventional non-contact conveyance device, the soft food materials are transformed along the curved gas guide surface of the conveyance head during conveyance and annular protrusions on surfaces of the food materials are formed. If the annular protrusions are formed on the surfaces of the food materials, it may be necessary to correct their shapes after the conveyance.

An object of the present disclosure provides a non-contact conveyance device capable of conveyance without deforming a conveyed object even if the conveyed object is soft.

A non-contact conveyance device of the present disclosure is a non-contact conveyance device that conveys a conveyed object while holding the conveyed object in a non-contact manner, the non-contact conveyance device having a conveyance head formed with a flat facing surface facing the conveyed object, an air supply port connected to a supply source of compressed air being provided in the conveyance head, each of ejection ports of a plurality of ejection paths communicating with the supply port and formed in the conveyance head being provided at a position separated by an opening distance from a holding center point of the facing surface, an inclination angle of the ejection path with respect to the facing surface being set to an acute angle, and the compressed air ejected from each of the ejection ports flowing along the facing surface and holding the conveyed surface without causing the conveyed object to contact with the facing surface.

Since the facing surface that holds the conveyed object in a non-contact manner is flat, even the soft conveyed object can be suppressed deformation when it is held and is conveyed by the conveyance head.

With the foregoing and other objects in view, there is provided, a non-contact conveyance device, which conveys a conveyed object while holding the conveyed object in a non-contact manner, comprising a conveyance head on which a flat facing surface opposing the conveyed object is formed, an air supply port connected to a supply source of compressed air and provided in the conveyance head, ejection ports of a plurality of ejection paths communicating with the air supply port and formed in the conveyance head, each of the ejection ports being provided at a position separated from a holding center point of the facing surface by an opening distance, and an inclination angle of each of the ejection paths with respect to the facing surface, the inclination angle being provided at an acute angle. The compressed gas ejected from each of the ejection ports flows along the facing surface, thereby holding the conveyed object without causing the conveyed object to contact with the facing surface.

In accordance with another feature, the plurality of ejection ports have a plurality of ejection port pairs, each of the plurality of ejection port pairs being paired by two of the ejection ports separated by an opening distance at positions on a same straight line that passes through the holding center point and extends along the facing surface.

In accordance with a further feature, the two of the ejection ports forming each of the ejection port pairs are separated by the same opening distance from the holding center point.

In accordance with an added feature, the ejection ports are provided so as to be shifted at regular intervals in a circumferential direction of the facing surface.

In accordance with an additional feature, each of the ejection ports is provided at a position with the same opening distance from the holding center point.

In accordance with yet another feature, a protrusion that protrudes from the facing surface and contacts with the conveyed object in conveying the conveyed object is provided in a range other than a range of a straight line connecting a holding center point and a center of a long radius of each of the ejection ports.

In accordance with yet a further feature, the protrusion is located radially inward from each of the ejection ports.

In accordance with yet an added feature, the protrusion is a rod-shaped protrusion extending in a radial direction of the facing surface.

In accordance with a concomitant feature, the protrusion includes the rod-shaped protrusion and a center protrusion that is formed integrally with a radially inner end of the rod-shaped protrusion.

### BRIEF DESCRIPTION OF THE DRAWINGS

FIG. 1 is a perspective view showing a conveyance head of a non-contact conveyance device according to one embodiment;

FIG. 2 is a plan view showing a facing surface of the conveyance head shown in FIG. 1;

FIG. 3 is a sectional view taken along line A-A in FIG. 2;

FIG. 4 is a sectional view of the conveyance head showing a gas layer formed along the facing surface by gas ejected from an ejection port;

FIG. 5 is a schematic diagram showing one example of the non-contact conveyance device having the conveyance head;

FIG. 6 is a perspective view showing a conveyance head of a non-contact conveyance device according to another embodiment;

FIG. 7 is a plan view showing a facing surface of the conveyance head shown in FIG. 6;

FIG. 8 is a sectional view taken along line B-B in FIG. 7;

FIG. 9 is a perspective view showing a conveyance head of a non-contact conveyance device according to yet another embodiment;

FIG. 10 is a plan view showing a facing surface of the conveyance head shown in FIG. 9;

FIG. 11 is a right-side view of FIG. 9;

FIG. 12 is a sectional view taken along line C-C in FIG. 10; and

FIGS. 13(A) and 13(B) are front views each showing the facing surface of the conveyance head according to another embodiment.

### DETAILED DESCRIPTION OF THE EMBODIMENTS

Hereinafter, embodiments will be described in detail with reference to the drawings. In the drawings showing the embodiments, common members are given the same reference numerals.

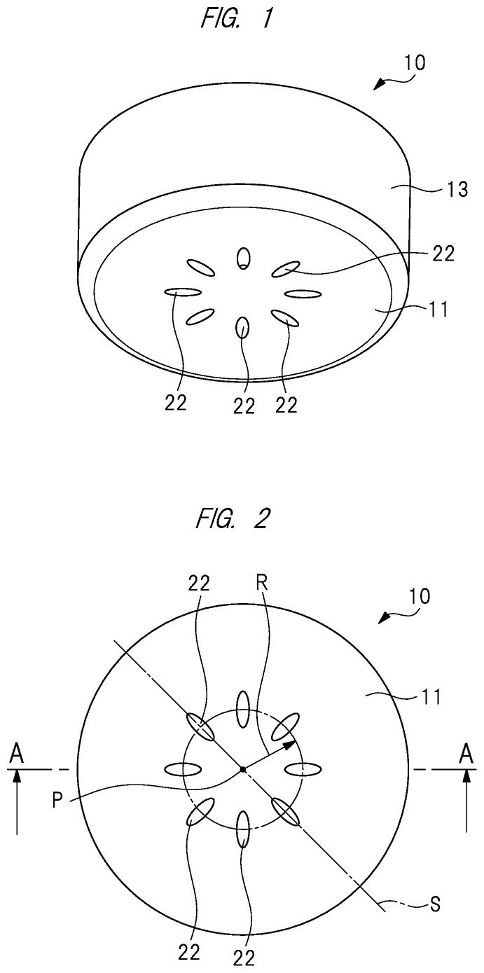

A conveyance head 10 of a non-contact conveyance device shown in FIGS. 1 to 3 is formed by a block material whose flat facing surface 11 is formed on its front side, the facing surface 11 and a back surface 12 on an opposite side thereof are circular, and an outer peripheral surface 13 is cylindrical. An air supply port 14 is formed in the conveyance head 10, and the air supply port 14 opens at the back surface 12 of the conveyance head 10.

As shown in FIG. 5, the conveyance head 10 is reciprocally movable, for example, between a first position A and a second position B by an unshown conveyance mechanism as indicated by an arrow C. An air supply joint 15 attached to a screw hole of the air supply port 14 is connected to a supply source 17 of compressed air, that is, a compressed gas by a gas supply tube 16, and compressed air from the supply source 17 such as a compression pump is supplied to the air supply port 14. A gas supply tube 16 is provided with an on-off valve 18 and a variable throttle valve 19. The on-off valve 18 switches between an open state in which the supply source 17 communicates with the gas supply port 14 and a closed state in which the communication is cut off. The variable throttle valve 19 regulates a flow rate of compressed air flowing from the supply source 17 to the air supply port 14. As shown in FIG. 5, an air supply mechanism for supplying compressed air to the conveyance head 10 and a conveyance mechanism for conveying and moving the conveyance head 10 constitute the non-contact conveyance device.

As shown in FIGS. 2 and 3, a center position of the facing surface 11 is a holding center point P, the air supply port 14 is formed at a position of a central axis 0 passing through the holding center point P and extending axially along the outer peripheral surface 13, and the central axis 0 of the air supply port 14 is coaxial with a central axis of the conveyance head 10.

Eight ejection paths 21 are formed in the conveyance head 10, and each ejection path 21 communicates with the air supply port 14. A center line Q of the ejection path 21 extends radially and is inclined with respect to the facing surface 11 at an inclination angle of an angle α. The ejection path 21 has its center line Q inclined so as to have an inclination angle of an angle β with respect to the central axis 0 of the air supply port 14. The angle α in the conveyance head 10 shown in FIG. 3 is 20 degrees and the angle β is 70 degrees. An ejection port 22 of each ejection path 21 opens to the facing surface 11, and the flat facing surface 11 is provided with eight ejection ports 22. Since the ejection path 21 extends in a radial direction of the conveyance head 10, the ejection port 22 is an elongated hole in which the radial direction of the facing surface 11 is a long diameter.

As shown in FIG. 2, centers of the long diameters of the eight ejection ports 22 are separated from the holding center point P by the same opening distance of a radius R. Further, the respective ejection ports 22 are arranged on the facing surface 11 with an equal interval of 45 degrees in a circumferential direction.

If the inclination angle of each ejection path 21 with respect to the facing surface 11 is set to an acute angle, the ejection port 22 has an elliptical shape with a long diameter in the radial direction. The two ejection ports 22 that are offset by 180 degrees in the circumferential direction are paired apart from each other by the same opening distance R at a position of the same straight line S that passes through the holding center point P and extends radially along the facing surface 11. Since the eight ejection ports 22 are arranged at equal interval of 45 degrees in the circumferential direction, the conveyance head 10 has four ejection port pairs. The straight line S connects the central axes of the long diameters of the two ejection ports 22 forming a pair. The opening distances R of the two ejection ports 22 forming a pair may be different from each other, or may be the same as shown in FIG. 2.

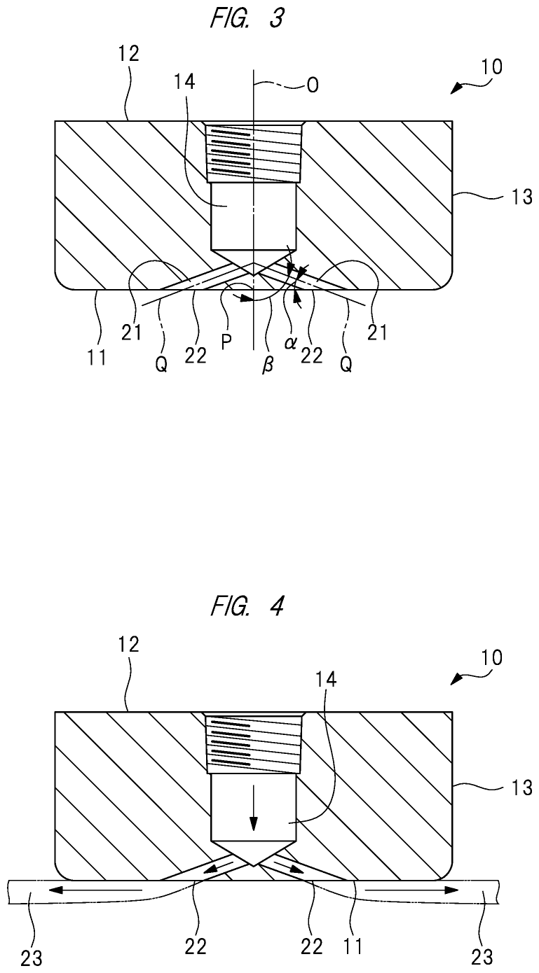

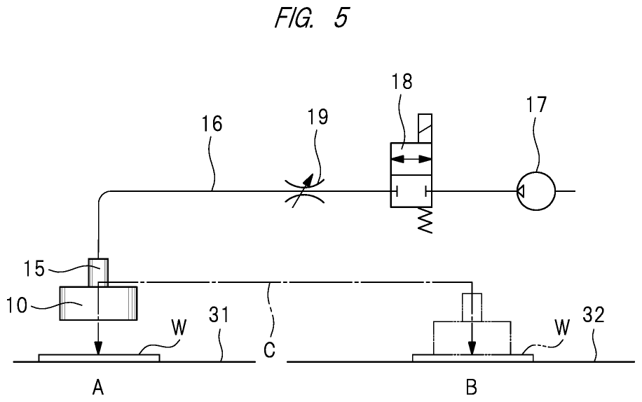

FIG. 4 is a sectional view of the conveyance head 10 showing a gas layer 23 formed along the facing surface 11. When compressed air is supplied to the air supply port 14 from the supply source 17, a gas layer 23 is formed on the surface 11 by the air ejected from the ejection port 22. The compressed air ejected from the ejection port 22 flows radially outward along the facing surface 11 since the ejection path 21 is inclined at an acute angle with respect to the facing surface 11. Since outside air is sucked from a front of the facing surface 11 toward the gas layer 23, the conveyed object approaches the facing surface 11 and is held at the facing surface 11 via the gas layer 23 without contacting with the facing surface 11 when the facing surface 11 is brought close to the conveyed object.

When the non-contact conveyance device having the conveyance head 10 shown in FIGS. 1 to 4 conveys a conveyed object W from the first position A to the second position B as shown in FIG. 5, the conveyance head 10 is brought close toward the conveyed object W placed at the first position A of a support table 31. When the facing surface 11 of the conveyance head 10 is brought close to a predetermined distance, the conveyed object W is drawn toward the facing surface 11 and is separated from the support table 31 via the gas layer 23 and is held on the facing surface 11 with non-contact.

Under this state, the conveyance head 10 is horizontally moved above a support table 32 by an unshown conveyance mechanism and is then moved downward. When the supply of compressed air to the air supply port 14 is stopped while the conveyed object W contacts with the support table 32 at the second position B, the conveyed object W is placed at the second position B of the support table 31.

Since the facing surface 11 of the conveyance head 10 is not a concave surface but a flat surface, the conveyed object W is held on the flat facing surface 11 via the gas layer 23. Therefore, the conveyed object W is conveyed in a flat state with its surface being curved. Consequently, even if the conveyed object is a soft food material such as pie crust, a curved or deformed portion such as a protrusion leads to being not formed on the conveyed object W after the conveyance, which makes work of correcting a shape of the conveyed object unnecessary.

In the above-mentioned conveyance head 10, the holding center point P is provided at the center position of the facing surface 11. However, even if a central axis of the cylindrical outer peripheral surface 13 and the holding center point P may be shifted from each other without coinciding with each other. Further, although the facing surface 11 is circular, it may be square, hexagonal, or the like depending on a type of the conveyed object. Also in such a case, the center position of the facing surface and the position of the holding center point P may be shifted from each other.

The inclination angle α may be any acute angle, and can be set to various angles according to the type and weight, etc. of the conveyed object. Moreover, the number of ejection ports 22 is not limited to eight as described above, can be set variously according to the type and weight, etc. of the conveyed object, and may be an even number or an odd number.

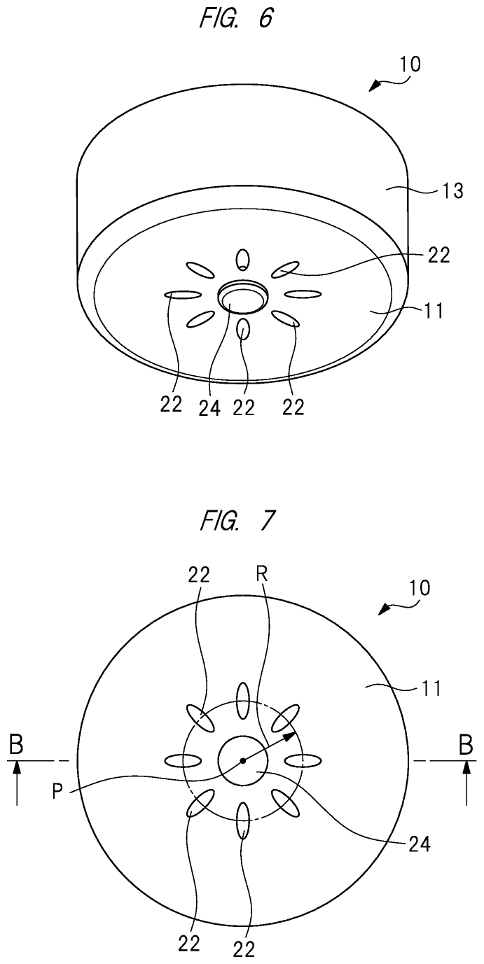

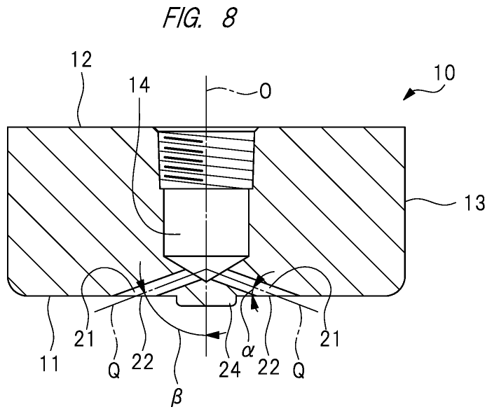

FIGS. 6 to 8 show a conveyance head 10 of another embodiment. A protrusion 24 is provided on the facing surface 11 of the conveyance head 10 so as to be integrated with the conveyance head 10. The protrusion 24 shown in FIGS. 6 to 8 is circular, and a position of its center point is set at a position of the holding center point P. An outer peripheral surface of the protrusion 24 is located on a radially inner side of the ejection port 22. A protruding height from the facing surface 11 may be equal to or greater than a distance between the facing surface 11 and the conveyed object when the conveyed object is held. The number of ejection paths 21 and ejection ports 22 is eight as in the above-described conveyance head 10, and the ejection ports 22 are opened in the facing surface 11 at equal intervals in the circumferential direction.

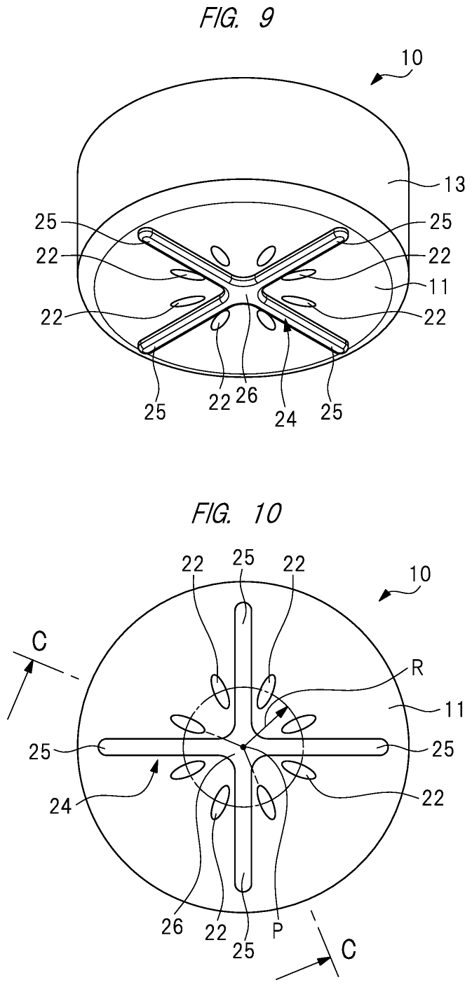

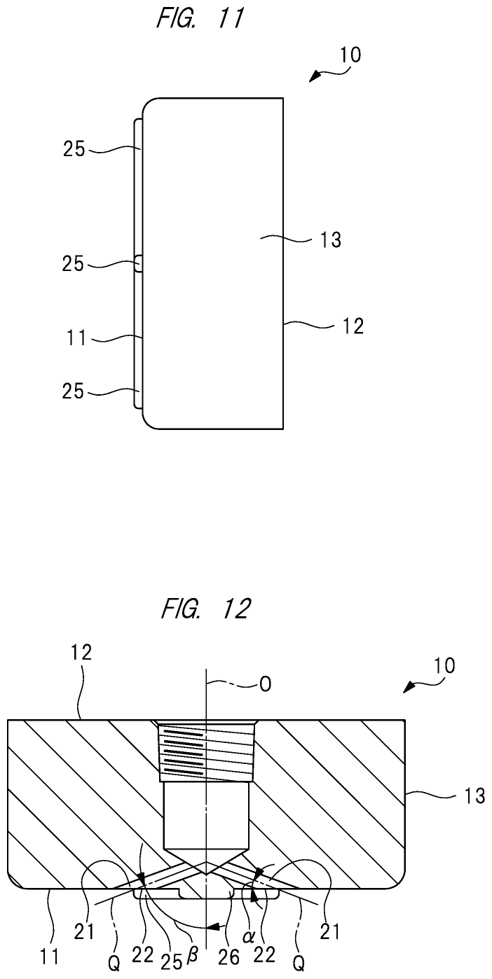

FIGS. 9 to 12 show a conveyance head 10 according to still another embodiment. A facing surface 11 of a conveyance head 10 is provided with four rod-shaped protrusions 25 and a protrusion 24 so as to be integrated with the conveyance head 10, the four rod-shaped protrusions 25 extending radially from a holding center point P of the facing surface 11, and the protrusion 24 being composed of a center protrusion 26 formed so that radially inner ends of the respective rod-shaped protrusions 25 are integrated.

The number of ejection ports 22 is eight as in the above-mentioned conveyance head 10. The protrusion 24, which is located between the two ejection ports 22 adjacent to each other in the circumferential direction and is composed of each rod-shaped protrusion 25 and the center protrusion 26, is provided integrally with the conveyance head 10 so as to protrude from the facing surface 11.

When the protrusion 24 is provided in this way, the conveyed object W comes into contact with the protrusion 24 in holding and conveying the conveyed object W in a non-contact state with the facing surface 11. Consequently, the conveyed object W is prevented from being shifted and moving along the facing surface 11 due to contact friction with the protrusion 24 during the conveyance. The facing surface 11 is flat, so that even if the conveyed object W is held in a partially contacting state with the protrusion 24, the conveyed object W is not curved or deformed if an appropriate holding force is set. Further, when the protrusion 24 is integrated with the conveyance head 10, the conveyance head 10 can be easily cleaned simply by removing the conveyance head 10 from the conveyance mechanism without disassembling the conveyance head 10, so that maintainability is improved. In addition, since the protrusion 24 is formed integrally with the conveyance head 10, the protrusion 24 does not come off from the conveyance head 10, which can prevent foreign matters from entering the conveyance object.

The shape of the protrusion 24 may be square or polygonal according to the type of the conveyed object, be provided with a plurality of protrusions 24, or be a shape composed of only a plurality of bar-shaped protrusions. Further, a position at which the protrusion 24 is provided may be a position depending on a type of a conveying object unless the position hinders a flow of the air elected from the ejection port 22. In order to hinder the flow of the air ejected from the ejection port 22, at least a straight line connecting the holding center point P and the center of the long diameter of the ejection port 22 needs to be made a flat surface without unevenness. As shown in FIG. 10, the rod-like protrusion 25 is provided in a range other than a range on the straight line connecting the holding center point P and the central axis of the long diameter of each ejection port 22.

Further, by adjusting a flow rate of the compressed air supplied to the conveyance head 10 thought the variable throttle valve 19 which is a holding force adjusting means, a holding force can be set to an appropriate strength according to the type and shape of the conveyed object. Instead of the variable throttle valve 19, a pressure reducing valve for adjusting air pressure supplied to the conveyance head 10 may be used as the holding force adjusting means.

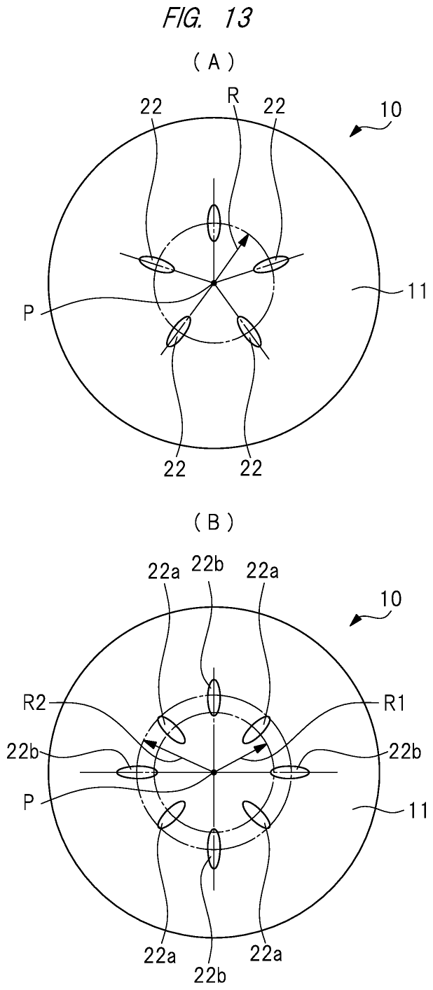

FIGS. 13(A) and 13(B) are front views each showing a facing surface of a conveyance head according to another embodiment.

In a conveyance head 10 shown in FIG. 13(A), five ejection ports 22 are formed in the facing surface 11, each ejection port 22 is separated from a holding center point P by the same opening distance R, and the ejection ports are shifted at regular intervals of 72 degrees in the circumferential direction. Thus, the number of ejection ports 22 is not limited to the number described above, and can be set to any number as long as the ejection port is plural in number. In order to hold the conveyed object well, it is preferable to provide a plurality of ejection ports 22 at regular intervals in the circumferential direction.

In a conveyance head 10 shown in FIG. 13(B), four ejection ports 22a separated by an opening distance R1 from the holding center point P and four ejection ports 22b separated by an opening distance R2 are formed on the facing surface 11. The two ejection ports 22a arranged at positions on the same straight line passing through the holding center point P and displaced by 180 degrees in the circumferential direction form an ejection port pair. Similarly, the two ejection ports 22b arranged at positions on the same straight line extending in the radial direction and displaced in the circumferential direction form an ejection port pair. A total of four ejection port pairs are provided on the facing surface 11. The number of ejection port pairs is not limited to four, and if the total is plural in number, the conveyed object can be held.

As described above, since the facing surface 11 that holds the conveyed object W in the non-contact manner is flat, even a soft conveyed object can suppress deformation when it is held by the conveyance head 10 and is conveyed. Consequently, even when soft foods such as bread dough, pie dough, and gyoza wrappers are conveyed, the food can be conveyed without deforming its shape. It is possible to eliminate the need for a process of correcting the shape after the conveyance. In particular, when soft food is to be conveyed, it is suitable in terms of ease of maintenance and prevention of contamination by foreign matters. Of course, the conveyed objects W are not limited to foods, and various products can be made conveyed objects as long as they are mass-produced products.

The present disclosure is not limited to the above-described embodiments and can be variously modified without departing from the gist of the present disclosure. For example, in the above-described embodiments, compressed air is ejected from the ejection port, but other positive pressure gas such as inert gas may be ejected from the ejection port.

### INDUSTRIAL APPLICABILITY

This non-contact conveyance device is used for conveying a conveyed object without bringing a conveyance head into contact with the conveyed object. In particular, it is suitable for conveying soft food materials such as pie dough and bread dough.

What is claimed is:

1. A non-contact conveyance device, which conveys a conveyed object while holding the conveyed object in a non-contact manner, comprising:
a conveyance head on which a flat facing surface opposing the conveyed object is formed;
an air supply port connected to a supply source of compressed air and provided in the conveyance head;
ejection ports of a plurality of ejection paths communicating with the air supply port and formed in the conveyance head, each of the ejection ports being provided at a position separated from a holding center point of the facing surface by an opening distance; and
an inclination angle of each of the ejection paths with respect to the facing surface, the inclination angle being provided at an acute angle,
wherein the compressed gas ejected from each of the ejection ports flows along the facing surface, thereby holding the conveyed object without causing the conveyed object to contact with the facing surface.

2. The non-contact conveyance device according to claim 1, wherein the plurality of ejection ports have a plurality of ejection port pairs, each of the plurality of ejection port pairs being paired by two of the ejection ports separated by an opening distance at positions on a same straight line that passes through the holding center point and extends along the facing surface.

3. The non-contact conveyance device according to claim 2, wherein the two of the ejection ports forming each of the ejection port pairs are separated by the same opening distance from the holding center point.

4. The non-contact conveyance device according to claim 1, wherein the ejection ports are provided so as to be shifted at regular intervals in a circumferential direction of the facing surface.

5. The non-contact conveyance device according to claim 1, wherein each of the ejection ports is provided at a position with the same opening distance from the holding center point.

6. The non-contact conveyance device according to claim 1, wherein a protrusion that protrudes from the facing surface and contacts with the conveyed object in conveying the conveyed object is provided in a range other than a range of a straight line connecting a holding center point and a center of a long radius of each of the ejection ports.

7. The non-contact conveyance device according to claim 6, wherein the protrusion is located radially inward from each of the ejection ports.

8. The non-contact conveyance device according to claim 6, wherein the protrusion is a rod-shaped protrusion extending in a radial direction of the facing surface.

9. The non-contact conveyance device according to claim 8, wherein the protrusion includes the rod-shaped protrusion and a center protrusion that is formed integrally with a radially inner end of the rod-shaped protrusion.
